(19) United States
(12) Patent Application Publication
(10) Pub. No.: US 2012/0078722 A1
(43) Pub. Date: Mar. 29, 2012

(54) Remotely controlled water treatment system and a method of remotely controlling a water treatment system

(75) Inventor: Patrick Van Oosterwijck, Cottage Grove, MN (US)

(73) Assignee: EcoWater Systems LLC, Woodbury, MN (US)

(21) Appl. No.: 13/076,390

(22) Filed: Mar. 30, 2011

Related U.S. Application Data
(60) Provisional application No. 61/318,955, filed on Mar. 30, 2010.

(51) Int. Cl. G06Q 50/06; G06Q 30/00; G06Q 30/06; G06F 15/16

(52) U.S. Cl. 705/14.58; 709/219; 705/26.41

(57) ABSTRACT

A water treatment system, such as a water softener, is remotely operated and a method of remotely controlling a water treatment system. In a first embodiment, the water treatment system having a web server is delivered and installed on the users LAN. The user PC is redirected by a remote server to the water treatment system by use of the water treatment system MAC address, IP protocol address and user information. In this manner, the user is able to control the water treatment system and communicate with the remote server. In a second and third embodiment, the water treatment system and user PC communicate indirectly via the remote server. In the second embodiment, the water treatment system is provided with a wireless network interface to couple to the remote server. In the third embodiment, the water treatment system is provided with an internet interface.

### CROSS-REFERENCE TO RELATED APPLICATION

This application claims the benefit of U.S. provisional application No. 61/318,955, filed Mar. 30, 2010, the contents of which are incorporated herein by reference.

### FIELD OF THE INVENTION

The present invention relates to water treatment systems in general and, in particular, a water softener which is remotely operated and a method of remotely controlling a water softener.

### BACKGROUND OF THE INVENTION

Water softening with ion exchange material, such as resin particles or the like, is well known in the art. During the softening process, typically called the service cycle, the ion exchange resin particles acquire hardness inducing ions from raw water which is being treated, in exchange for soft ions. That is, ions which do not induce hardness to water. After continued contact of the resin particles with hard raw water, the particles ion exchange capacity is considerably diminished and regeneration of the resin particles must be accomplished, conventionally by contacting the resin particles with a brine solution, i.e., an aqueous solution of sodium chloride or potassium chloride or the like, during a regeneration cycle.

The ion exchange process, which takes place during the regeneration of the ion exchange material, is accomplished in a softener or resin tank of well known construction. A separate brine tank is conventionally used to form brine for use during the regeneration cycle. When regeneration is initiated in the softener system, brine drawn from the brine tank passes through the bed of ion exchange material in the softener tank to reverse the exchange of ions and revitalize the bed by removing hardness inducing ions and replacing them with sodium ions, for example, from the brine.

The amount of brine which is required to regenerate a bed of ion exchange material of a predetermined volume, is dependent upon the extent to which the bed is exhausted during the service cycle. This, in turn, is dependent upon a number of factors, including: (1) the hardness of the water being treated; and (2) the quantity of water treated during the service cycle. The cost of operating the softening system may be reduced by limiting the amount of salt utilized in each regeneration cycle and the frequency of regeneration cycles to only that necessary to regenerate the resin particles.

Historically, most water softeners are designed to regenerate on a predetermined timed cycle which is determined by taking into consideration the above-mentioned factors. The water softening system regenerates itself on the predetermined time cycle even if the water softening system is subjected to either an abnormally high or low usage during a particular period of time. In the instance of abnormally low usage, a waste of salt and water results. In the instance of abnormally high usage, the water softening system is unable to adequately soften all of the water passing through the system.

Many control systems have been proposed to take into account water usage on a real time basis. Such systems have been based upon means which detect the state of exhaustion of the resin bed or means which measure the quantity of water which has passed through the resin bed since the most recent regeneration cycle.

Systems which attempt to detect the state of exhaustion of the resin bed are disclosed in U.S. Pat. Nos. 3,246,759 and 4,257,887. One example of a softening control system which utilizes a means to measure the quantity of water which has passed through the bed is disclosed in U.S. Pat. No. 3,687,289. U.S. Pat. Nos. 6,456,202 and 6,696,963, both of which are incorporated by reference herein, disclose systems wherein the status of a water softener is monitored and provided an indication that salt is low or that the system requires servicing. U.S. Pat. No. 6,085,788 disclose a water flow valve for controlling the flow of water through a water softener system during the various cycles, including the service cycle and regeneration cycle, and is incorporated herein by reference.

As will be appreciated from the above, it will be necessary to periodically add salt to the brine tank. It will be further appreciated that the timing and amount of salt required is a variable. In order to provide uninterrupted service, it is necessary to anticipate when the salt must be added and the amount required. In particular, it is advantageous to have a specific amount of salt on hand as necessary. Thus, typically the user will be required to monitor the salt level, either through visual observation of the level of salt or via an indicator of a salt monitor. Further, it is also necessary for the user to monitor that the water softener is operational. Again, such monitoring may be via visual observation of the water softener or via an indicator of a system monitor.

Further, even before any of the forgoing may be initiated, it is necessary that the water softener be installed and set up at the location of operation. Such installation and setup may be done the owner operator or via a person or firm hired to handle such setup. Thereafter, it is necessary to monitor and maintain the system.

### SUMMARY OF THE INVENTION

The present invention provides various embodiments for simplifying the setup and ongoing operation and maintenance of a water treatment system, such as a water softener. In particular, a user or user representative is able to setup and operate a water treatment system via the user's personal computer or similar device. The interface between the user's personal computer and the water treatment system is simplified by the present invention.

In a first embodiment, a water softener is provided with a web server and a media access control address (MAC address). The MAC address is assigned to the softener by the manufacturer. A MAC address is unique for any network adapter or network interface card. The MAC address typically resides in a device's nonvolatile memory and is also usually printed on a sticker located on the device.

The water softener may be programmed via, or communicates with, a main server, such as provided by a water treatment service provider, and a user's personal computer or similar device. The web server is capable of communicating via a local area network (LAN) with the internet, main server and the user's personal computer. The cost of the system may be reduced where the local area network is provided by the user or customer. The LAN may be wired or wireless. A router/modem of the LAN may provide the access point for the web server of the water softener. In a wireless LAN arrangement, the setup may consist of turning on the water softener. The water softener detects or is otherwise directed to the user's wireless connection and prompts for, or otherwise is provided, the encryption key, such as wired equivalent privacy (WEP), Wi-Fi protected access (WPA) and IEEE 802.11 i (WPA2). The softener then gets connected to the router and obtains a local network internet protocol (IP) address using the dynamic host configuration protocol (DHCP). The water softener is now able to communicate with the main server. The water softener provides the main server with the MAC address and the then current local network IP address. The water softener communicates with the main server whenever it obtains a new local network IP address, and provides the new IP address to the main server, together with the constant MAC address. The main server may maintain a table to keep track of the MAC address and the current local IP address. All of the foregoing may be conducted automatically, with the possible exception of providing the encryption key.

After the water softener establishes communication with the main server as described above, the user is instructed in the user's manual or on an instruction sheet to direct the browser of the user's personal computer to a particular web site. The web site may be associated with the main server and the water treatment service provider. The user may be required to register or setup an account. The user will be prompted to locate and enter the MAC address of the water softener. Alternatively, the user may be instructed to point the user browser to the URL with the MAC address as an extension of the URL address. The main server will associate the MAC address with the user provided information, such as the user name and address. As suggested above, the MAC address might be provided on a sticker, label or tag, located on the water softener. The main server will cross reference the MAC address in the table and obtain the current IP address of the water softener. In this way, the main server is capable of associating the user with the water softener located at the user site. The main server will then redirect the browser of the user's personal computer to the current IP address of the water softener. The user's browser is now directly connected to the web server running in the water softener.

With the user's browser directly connected to the web server, the user may be prompted for various information for the purpose of providing additional user information, programming the water softener, and providing user preference information. For example, the water softener might serve web pages to the user's personal computer requesting such information. By means of the web forms, the user is now able to perform any configuration that would typically be done on the water softener faceplate. This system provides the benefit of using a larger screen of the user's personal computer in contrast to the typical small screen associated with a water softener display. Thus there is much greater flexibility as to the manner and amount of information presented to the user. The pages may provide graphics, diagrams, embedded movies or hyperlink to pages resident on the main server or elsewhere. Further, implementing various languages is easier as font management is not necessary. The use of HTML merely requires that the correct language information be sent and the browser will display the information accordingly. It will be appreciated that web pages will be easily revised and updated as desired. The updated pages may be provided by the main server to the water softener.

Information requested from the user may include the location of the water softener. The location of the water softener may be used to determine a default setting for water hardness and iron levels. Further, the location may be used to provide messages regarding any known contaminants in the water. Further, recommended action may also be provided such as in the event a contaminant is identified in the source of water or in areas adjacent to the water softener. The location information is also relevant in the event the main server provides the current time to the softener during setup or after power returns subsequent to a power outage.

Since the user is connected directly to the water softener, all changes are implemented immediately and without delay. It will be understood that the first embodiment does not require that the water softener poll the main server for updated information from either the main server or the customer.

Various services may also be offered to the customer in accordance with the present invention. A service setup might follow the water softener setup. The present invention may offer various levels of services, such as: no service; self service; delivery service; and full service. In the event the customer elects no service, one embodiment provides two sublevels. The first sublevel allows the user to proceed without setting up an account. The present invention does not simplify the setup. The user must interface with the softener in order to setup the softener. It will be necessary for the user to enter the softener's MAC address whenever the user desires to change the softener settings. Alternatively, in the second sublevel, the user may set up an account but selects no service. In this instance, the present invention is capable of simplifying the setup in accordance with the comments above.

If the user selects the self service, the present invention is capable of simplifying the setup. In addition, the user may direct that status messages be sent via email or text messages to a particular email address or SMS number. The status message might indicate the amount or level of salt remaining or that there is a system error, for example. Further, basic water use statistics may be available to the user.

In the event the user selects delivery service, a third party receives the low salt notice and delivers the salt to the customer site. In addition, if the softener requires service, a service person will be notified automatically. Further, basic or detailed water use statistics may be available to the user.

In the event the user selects full service, additionally, a third party loads the salt into the brine tank. The service person may update the salt level either via the softener user interface or over the internet. In this instance, the softener user interface may be omitted for a system cost savings. The user may specify time slots for delivery.

It will be appreciated that the various services may be administered by the main server. Further, the main server has the ability, subject to privacy issues, to develop a database of water statistics for various geographical areas and demographics.

In addition, if a user elects, detailed water usage information or reports may be provided to the user. For example, the user may be provided with daily water use over a month, average hourly water use, average water use per day of the week. An option may also be provided to the user to participate in collecting statistical information on water usage. The user may benefit from the knowledge gained from the information. Further, additional benefits might be offered to the user in return for participating in such information collection. For example, the usage patterns may be used to adjust the software algorithm used to adjust the reserve capacity of the softener to provide soft water for the remaining portion of the day after the need for a regeneration is signaled. The user may also elect to participant in automatic online diagnostic testing and troubleshooting, with the option of automatically requesting a service visit.

In systems having a reverse osmosis (RO) filter, the system may advise as to when the RO filter or membrane should be replaced. Similarly, iron filters are another example of water treatment systems which may benefit from the present invention.

It will be appreciated that the water softener may be controlled by the main server. For example, if the user fails to comply with the terms of the service contract, the water softener may be turned off until the user complies with the terms of the contract. Additionally, if the user unplugs the internet connection, the water softener will detect such an occurrence and will respond in accordance with a factory programmed or default action, such as disabling the regeneration cycle.

In a second embodiment, a water softener may be provided without a web server. The water softener is not connected to the main server via the LAN. Rather, the water softener is connected to the main server via a cellular modem or other wireless network. The cellular modem or other wireless network is not provided by the user. The user's PC and internet connection, such as a router/modem, may be located at the user softener installation site. However, the user PC and internet connection may be located elsewhere. It will be appreciated that in this embodiment, the user is unable to communicate directly with the water softener via the user's web browser. Rather, the user's PC communicates with the main server via the user's web browser to provide the desired user settings for the water softener. In one embodiment, the water softener polls the main server for updates from both the main server and from the user. The second embodiment has the advantage that it is not dependent on the user's network. However, the setup is still simplified for the user.

In a third embodiment, a water softener is not provided with a web server. The water softener is connected to the main server via a LAN, such as the user's router/modem, or other internet connection. The user's PC and internet connection, such as a router/modem, may be located at the user softener installation site and, in fact, may be the same internet connection as used by the water softener. However, the user PC and internet connection may be located elsewhere. It will be appreciated that in this embodiment, the user is unable to communicate directly with the water softener via the user's web browser. Rather, the user's PC communicates with the main server via the user's web browser to provide the desired user settings for the water softener. In one embodiment, the water softener polls the main server for updates from both the main server and from the user.

In all three embodiments described above, the water softener may have a universal serial bus (USB) or other interface to allow a dealer or other individual to connect a PC directly to the water softener for communication with or programming of the water softener, or for downloading of newer software versions.

It will be appreciated that the phrase personal computer or PC may include other devices, such as, but not intended to be limited thereto, a cell phone, internet tablet and other mobile devices. Further, such devices typically may include a web browser or similar application or feature. The phrases web browser and web server are intended to include other similar applications, respectively. U.S. Patent Application Publication N. 2003/0038839 discloses an example of a method for a web based service and U.S. Patent Application Publication No. 2005/0215244 discloses an example of a device and method for monitoring a meter, and are both incorporated herein by reference. In addition, it will be appreciated that the main server or the water softener web server may include an application programming interface for web services to allow application software or desktop widgets, or similar feature, to access the relevant data.

### BRIEF DESCRIPTION OF DRAWINGS

FIG. 1 is a block diagram of a system including a water treatment system in accordance with a first embodiment of the present invention.

FIG. 2 depicts a screen shot during a user setup of the water softener, wherein the user may provide a zip code in order to set a default hardness setting based on the location of the water softener or alternatively to set the hardness level if known, and further to order a hardness kit if desired.

FIG. 3 depicts a screen shot of providing a user with a contaminant alert based on the known location of the water softener.

FIG. 4 shows the customer records and other data which are obtained and maintained by a server, such as shown in FIG. 1.

FIG. 5 is a block diagram of the water treatment system of FIG. 1.

FIG. 6 is a plan view of a label providing a unique identifier.

FIG. 7 is a block diagram of a system including a water treatment system in accordance with a second embodiment of the present invention.

FIG. 8 is a block diagram of the water treatment system of FIG. 7.

FIG. 9 is a block diagram of a system including a water treatment system in accordance with a third embodiment of the present invention.

FIG. 10 is a block diagram of the water treatment system of FIG. 9.

### DETAILED DESCRIPTION OF THE INVENTION

FIG. 1 shows one example of a water treatment system, in accordance with the above described first embodiment. The system of FIG. 1 includes a water softener system 10, having an Ethernet port 12 coupled to the Ethernet port 14 of a combination router/modem 16, via an Ethernet cable 18. A personal computer 20 includes an Ethernet port 22 coupled to an Ethernet port 24 of the router/modem 16, via an Ethernet cable 26. The PC 20 includes web browser software capable of retrieving, presenting, and traversing information resources on the world wide web, as well as accessing information provided by web servers in private networks. Examples of such software include INTERNET EXPLORER, FIREFOX and CHROME. It will be appreciated that the router/modem 16 may be coupled to the water softener system 10 and PC 20 via other interface devices, such as, but not limited to, a USB or wireless connection, provided that the water softener system 10 and PC 20 are provided the appropriate corresponding interface, as is known in the art. The modem portion of the router/modem 16 may be a DSL modem or cable modem, or similar device. The combination router/modem 16 is shown as being couple via a cable 30 to the internet 32, in a manner as known in the art. The combination router/modem 16 may also be comprised of separate components, rather than the combined system as shown, as is known in the art.

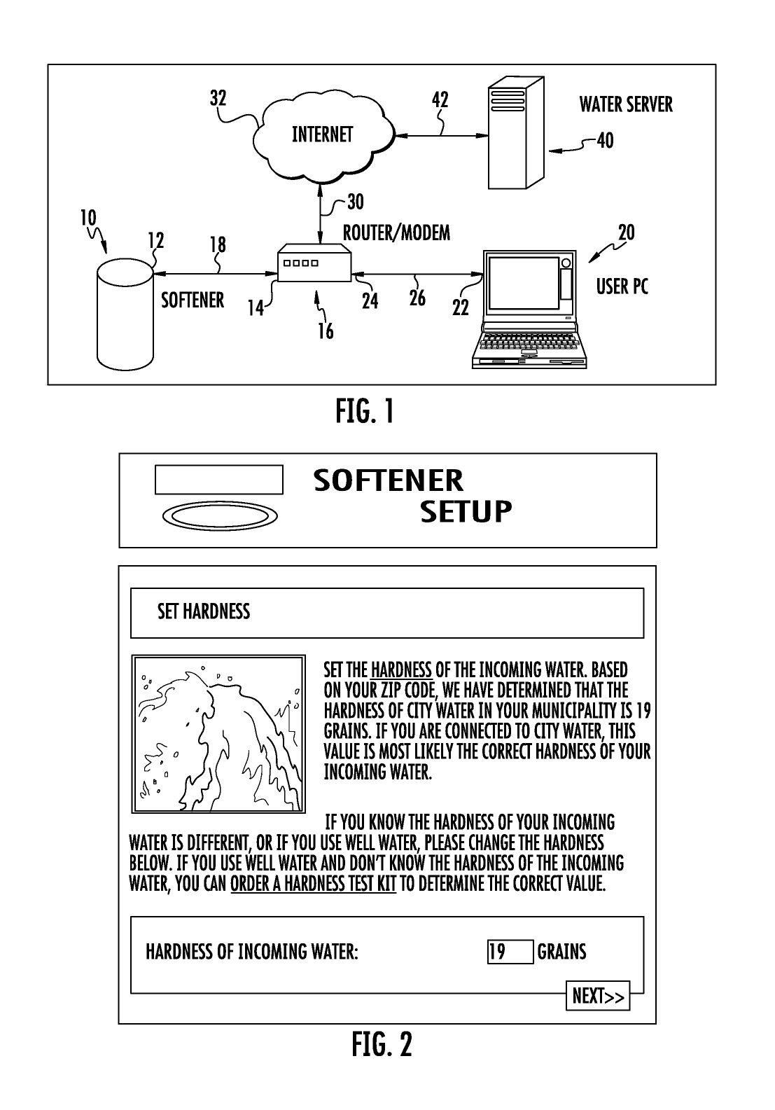

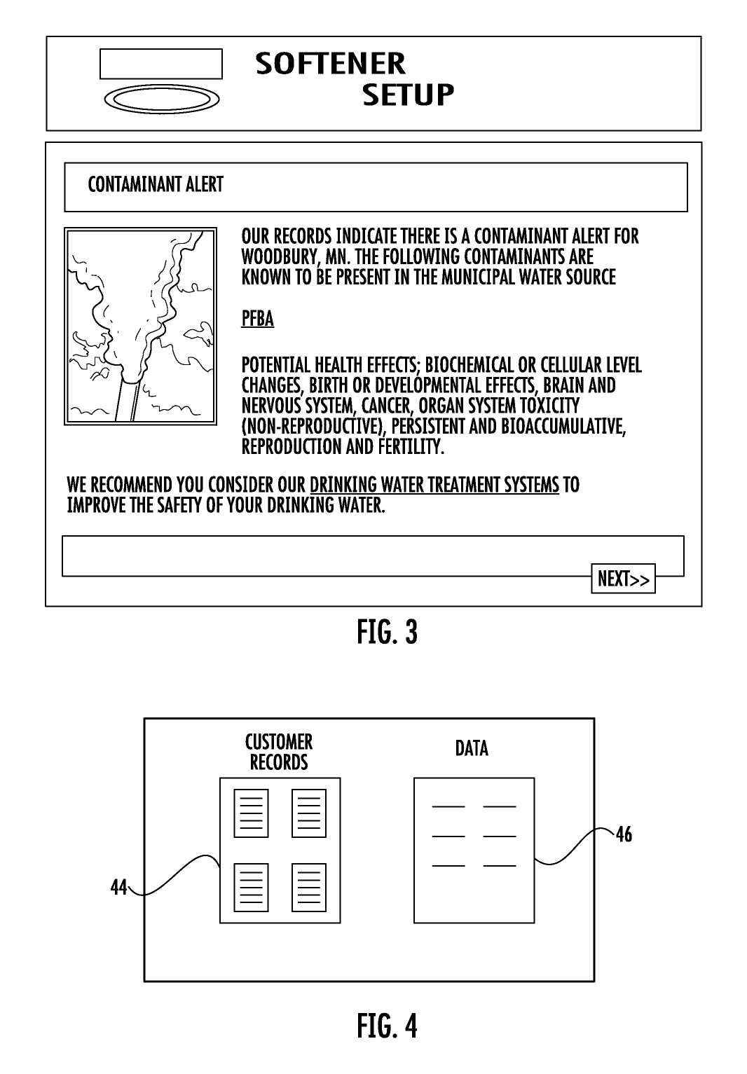

In the embodiment of FIG. 1, the water softener system 10, router/modem 16 and PC 20 are located at the customer softener installation site. A server 40 is shown and is at a location remote from the customer softener installation site. The server 40 is capable of communicating over the internet 32 via a connection 42 which may comprise any one of various methods as known in the art. Further, the server 40 includes web server software capable of delivering content, such as web pages, to a client. The content may be delivery of HTML documents. For example, see the screen shot provided in FIGS. 2 and 3. Examples of web server software include MICROSOFT IIS and GOOGLE GWS. The server 40 further maintains records 44 of customers with various fields related to the customer data, equipment, and services. In addition, the server may maintain other data 46, such as data on water hardness in specific locations and data regarding water containments identified in specific locations. FIG. 4 shows the customer records 44 and data 46. In addition, the server 40 may be associated with various URLs in a manner as described above. For example, the URL may be the combination of the service providers home URL and a unique identifier as described herein.

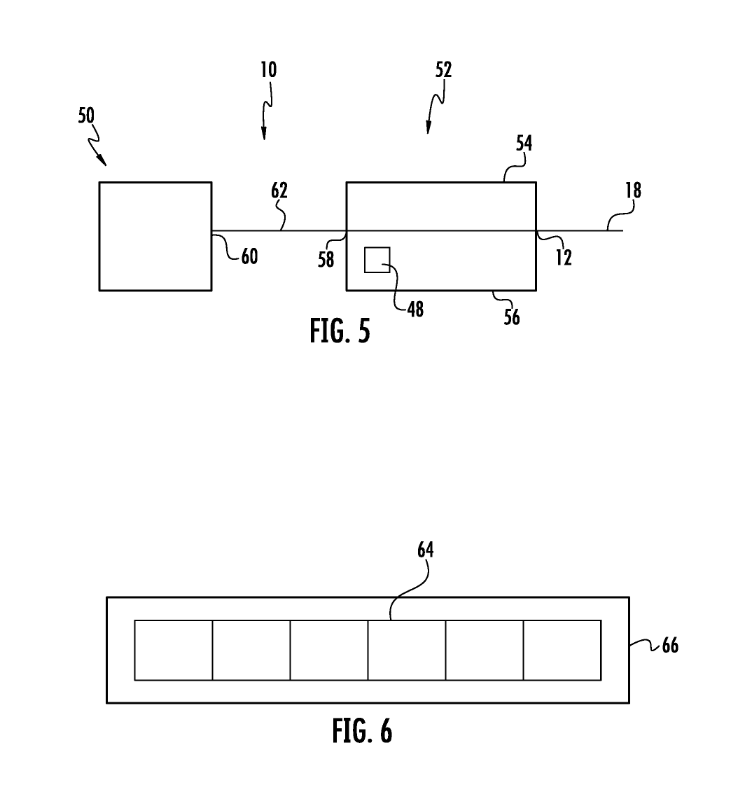

FIG. 5 is a block diagram of one embodiment of the water softener system 10. The water softener system 10 is shown to include a water softener 50 coupled to a control system 52. The control system 52 and water softener 50 may be a unitary system. Alternatively, the control system 52 may be separate from the water softener 50. In fact, it will be appreciated that the control system 52 might take the form of a personal computer, with the appropriate software installed. The control system 52 includes a controller 54 and communications interface device 56. The controller 54 includes web server software capable of delivering content, such as web pages to a client, such as the PC 20. The content may be delivery of HTML documents. For example, see the screen shot provided in FIGS. 2 and 3.

The controller system 52 includes a port 58 coupled to a port 60 of the water softener 50 via data and control lines 62. The controller 52 is capable of requesting and storing a local network IP address 48. The communications interface device 56 includes the MAC address, or similar unique identifier 64, such depicted in the label 66 shown in FIG. 6. The device 56 also includes the Ethernet port 12.

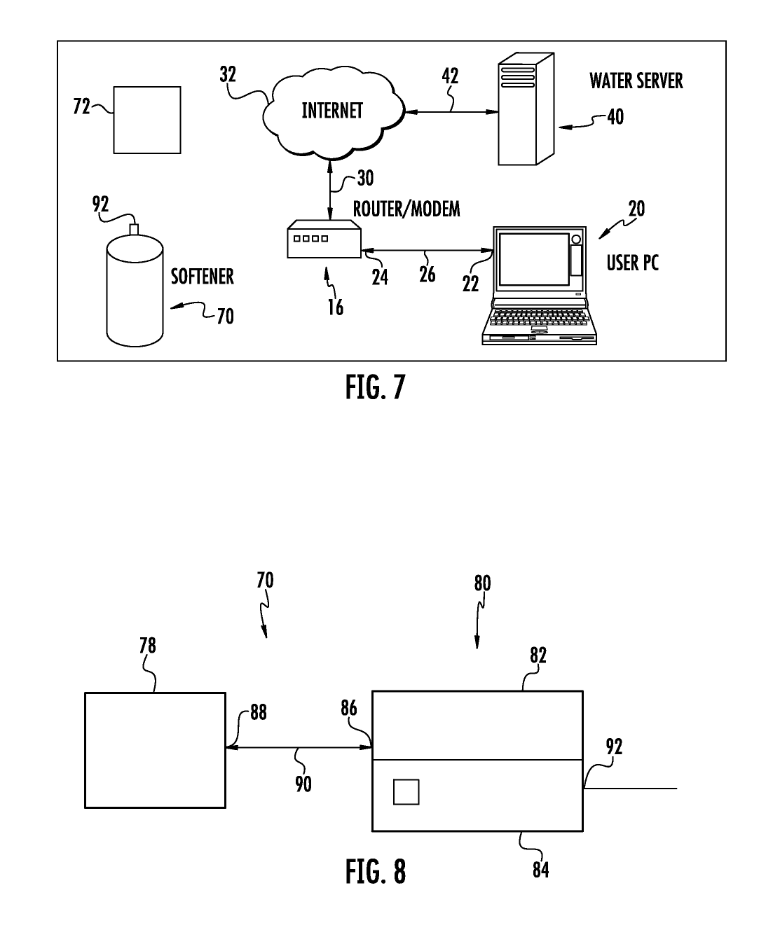

FIG. 7 shows one example of the above described second embodiment of the present invention. A water treatment system, such as a water softener system 70 is coupled to a wireless network 72, such as a public wireless network or cellular modem. The water softener system 70 is located at a customer softener installation site. However, the water softener system 70 does not require a LAN provided by the user.

At a location which may or may not be remote from the customer softener installation site, a PC 20 and router/modem 16 are provided. The PC 20 includes an Ethernet port 22 coupled to an Ethernet port 24 of the combination router/modem 16, via an Ethernet cable 26. The PC 20 includes web browser software capable of retrieving, presenting, and traversing information resources on the world wide web, as well as accessing information provided by web servers in private networks. It will be appreciated that the router/modem 16 may be coupled to the PC 20 via other interface devices, such as, but not limited to, a USB or wireless connection, provided that the router/modem 16 and PC 20 provide the appropriate corresponding interface, as is known in the art. The modem portion of the router/modem 16 may be a DSL modem or cable modem, or similar device. The router/modem 16 is shown as being couple via a cable 30 to the internet 32, in a manner as known in the art. The combination router/modem 16 may also be comprised of separate components, rather than the combined system as shown, as is known in the art. In fact, the router function is not necessarily required in this embodiment.

In the embodiment of FIG. 7, a server 40 is shown and is at a location remote from the customer softener installation site. The server 40 is capable of communicating over the internet 32 via a connection 42 which may comprise any one of various methods as known in the art. Further, the server 40 may include web server software capable of delivering content, such as web pages, to a client. The content may be delivery of HTML documents. For example, see the screen shots provided in FIGS. 2 and 3.

FIG. 8 is a block diagram of one example of the water softener system 70. The water softener system 70 is shown to include a water softener 78 coupled to a control system 80. The control system 80 and water softener 78 may be a unitary system. Alternatively, the control system 80 may be separate from the water softener 78. In fact, it will be appreciated that the control system 80 might take the form of a personal computer, with the appropriate software installed. The control system 80 includes a controller 82 and communications interface device 84. The controller 82 includes software capable of running a routine which periodically establishes a connection with the server 40 and polls the server 40 for any content, data, instructions, or the like, for the water softener system 70, or to provide content, data, instructions, or the like, to the server 40. It is not required, for the second embodiment, that the controller 80 is provided with web server software.

The controller system 80 includes a port 86 coupled to a port 88 of the water softener 78 via data and control lines 90. The communications interface device 84 includes a wireless network interface port 92. The wireless network interface port 92 allows the water softener system 70 to establish communication with the wireless network 72, which ultimately allows communication with the server 40, in a manner as is known in the art. A serial number, MAC address, or similar unique identifier 64, is provided with the water treatment system. For example, the identifier 64 may be provided on a label 66 affixed to or otherwise provided with the system.

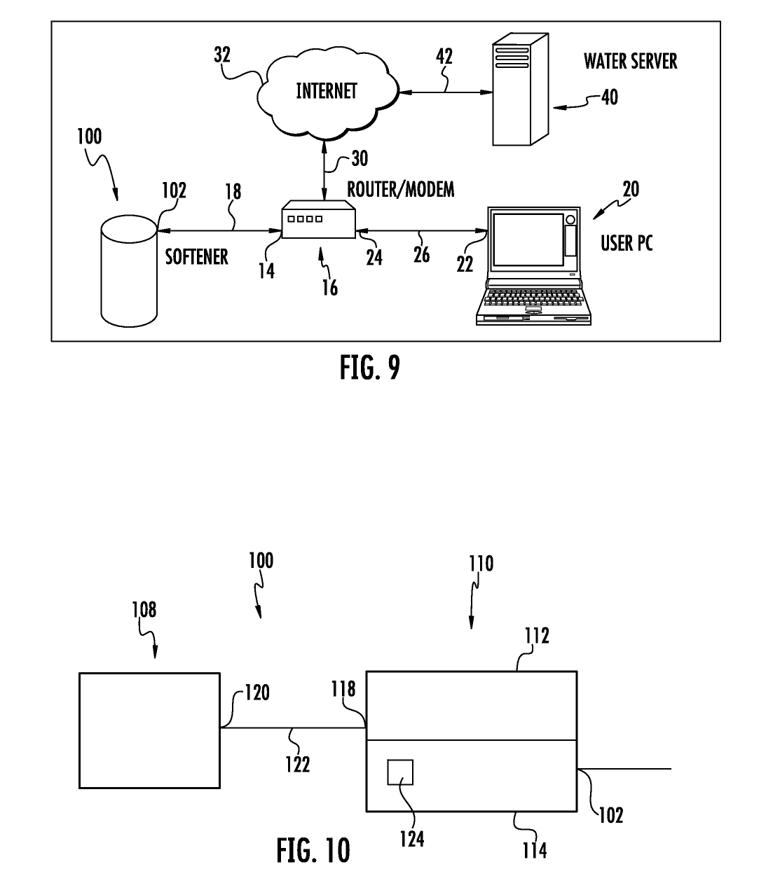

FIG. 9 discloses one example of the above described third embodiment of the present invention. The system includes a water softener system 100, having an Ethernet port 102 coupled to the Ethernet port 14 of a combination router/modem 16, via an Ethernet cable 18. A personal computer 20 includes an Ethernet port 22 coupled to an Ethernet port 24 of the router/modem 16, via an Ethernet cable 26. However, the third embodiment does not require that the PC 20 couple to the internet via the same LAN or internet interface as the water softener system 100. The PC 20 includes web browser software capable of retrieving, presenting, and traversing information resources on the world wide web. It will be appreciated that the router/modem 16 may be coupled to the water softener system 100 or PC 20 via other interface devices, such as a USB or wireless connection, provided that the water softener system 100 or PC 20 are provided the appropriate corresponding interface, as is known in the art. The modem portion of the router/modem 16 may be a DSL modem or cable modem, or similar device. The combination router/modem 16 is shown as being couple via a cable 30 to the internet 32, in a manner as known in the art. The combination router/modem 16 may also be comprised of separate components, rather than the combined system as shown, as is known in the art.

In the embodiment of FIG. 9, the water softener system 100 and router/modem 16 are located at the customer softener installation site. As suggested above, the PC 20 may or may not be located at the customer softener installation site. If the PC 20 is not located at the customer softener installation site, then the router function of the router/modem 16 may not be required. Further, another internet interface, such as a modem, will be required at the location of the PC 20 for coupling the PC 20 to the internet. In addition, a server 40 is shown and is at a location remote from the customer softener installation site. It is not likely, but not necessarily prohibited, that the server 40 and PC 20 would be at the same location. The server 40 is capable of communicating over the internet 32 via a connection 42 which may comprise any one of various methods as known in the art. Further, the server 40 includes web server software capable of delivering content, such as web pages, to a client, such as the PC 20. The content may be delivery of HTML documents. For example, see the screen shots provided in FIGS. 2 and 3. The server 40 further maintains records 44 of customers with various fields related to the customer data, equipment, and services. In addition, the server 40 may maintain other data 46, such as data on water hardness in specific locations and data regarding water containments identified in specific locations. FIG. 4 shows the customer records 44 and data 46. In addition, preferably, the server 40 is associated with one or more URLs which are associated in name with the water treatment system and service provider, to provide a URL more readily recalled by the customer.

FIG. 10 is a block diagram of one example of the water treatment system 100 of FIG. 9. The water softener system 100 is shown to include a water softener 108 coupled to a control system 110. The control system 110 and water softener 108 may be a unitary system. Alternatively, the control system 110 may be separate from the water softener 108. In fact, it will be appreciated that the control system 110 might take the form of a personal computer, with the appropriate software installed. The control system 110 includes a controller 112 and communications interface device 114. The controller 110 does not require web server software.

The controller system 110 includes a port 118 coupled to a port 120 of the water softener 108 via data and control lines 122. The controller 112 is capable of requesting and storing a local network IP address 124. The controller 112 or communications interface device 114 includes the MAC address, or similar unique identifier 64, such depicted in the label 66 shown in FIG. 6. The label 66 may be provided on the water treatment system 100. In any event, the unique identifier 64 is provided with the system to associate the system with the customer. The communication interface device 114 also includes the Ethernet port 102.

It should be apparent to those skilled in the art that what has been described is considered at present to be a preferred embodiment of the system and method. However, in accordance with the patent statutes, changes may be made in the system and method without actually departing from the true spirit and scope of this invention. The appended claims are intended to cover all such changes and modifications which fall within the true spirit and scope of this invention.

I claim:

1. A method of controlling a water treatment system at a customer water treatment system installation site, wherein the customer water treatment system installation site includes a router capable of connecting to a network, wherein the customer or a representative of the customer has access to a personal computer having a web browser and capable of connecting to the network, the method comprising the steps of:
providing a main server at a location remote from a customer water treatment system installation site;
providing a water treatment system having a web server and a unique identification (i.e., MAC) to be located at the customer water treatment system installation site;
establishing a connection between the water treatment system and the main server, the connection via a router located at the customer water treatment system installation site;
receiving at the main server the unique identification (MAC) of the water treatment system and a network address (i.e., IP protocol address) of the water treatment system, via the water treatment system;
establishing a connection between a personal computer and the main server;
receiving at the main server an association (i.e., customer identification and respective MAC) between the customer and the water treatment system;
redirecting a web browser of the personal computer to the web server of the water treatment system, based on the association between the customer and the water treatment system.

2. The method of claim 1, wherein the step of providing a water treatment system having a unique identification includes providing a water treatment system having a media access control address and an interface card capable of receiving an internet protocol address.

3. The method of claim 1, wherein the step of initiating a connection includes automatically initiating the connection.

4. The method of claim 1, wherein the step of receiving a unique identification and a network address includes automatically receiving a local internet protocol address of the water treatment system and a media access control address assigned to the water treatment system.

5. The method of claim 1, wherein the step of receiving at the main server the association includes receiving a media access control address associated with the water treatment system and respective customer related information, via the personal computer.

6. The method of claim 1, wherein the step of establishing a connection includes establishing a connection between the personal computer and the main server, via the customer's router, wherein the personal computer is located at the customer water treatment system installation site.

7. The method of claim 1, further comprising the step of presenting via the main server to the personal computer a web based form, and receiving user provided information regarding the user, requested services, or data to be used for programming of the water treatment system.

8. The method of claim 1, further comprising the step of presenting via the water treatment system to the personal computer a web based form, and receiving user provided information, and data to be used for programming the water treatment system per the user provided information.

9. The method of claim 1, further comprising the step of the main server receiving user provided information identifying the location of the water treatment system, and the step of the main server providing a default settings for city water hardness and iron levels based on the zip code where the water treatment system is located, and further providing the step of the main server advising the user of any known contaminants in the water within the zip code area where the water treatment system is located, wherein the step of advising may be via email, a text message, a message delivered to the water treatment system, or via the main server when the user connects to the main server, and further comprising the step of recommending the purchase of a reverse osmosis filter to customers having a water treatment system located in an area where contaminants are located in the water source.

10. The method of claim 1, further comprising the step of determining by the water treatment system that it has been assigned a new network address, and further comprising the step of communicating by the water treatment system to the main server and providing the main server with the new network address.

11. The method of claim 1, further comprising the step of detecting that a salt level in the water treatment system is low, and the step of either notifying the customer that the salt level is low, or ordering a supply of salt be delivered, or dispatching a service personnel to the location to add salt to the water treatment system.

12. The method of claim 11, further comprising the step of selecting a supplier of services or product such as salt, wherein the selecting includes certain criteria.

13. The method of claim 1, further comprising the step of receiving user provided information regarding the user, including an email address or SMS number of the user, and further comprising the step of dispatching an email or text message to the user advising of various sales or promotional, or the status of the water treatment system.

14. The method of claim 1, further comprising the step of receiving, by the main server, user requests for revised or additional service or product.

15. A method of controlling a water treatment system at a customer water treatment system installation site, wherein the customer or a representative of the customer has access to a personal computer capable of connecting to a network, the method comprising the steps of:
providing a main server at a location remote from a customer water treatment system installation site;
providing a water treatment system having a controller, a wireless network interface and a unique identification (i.e., factory setting), the water treatment system to be located at the customer water treatment system installation site;
(automatically) initiating a connection between the water treatment system and the main server, the connection via a non-customer wireless network;
receiving at the main server the unique identification of the water treatment system, via the water treatment system;
establishing a connection between the personal computer and the main server;
receiving at the main server an association (i.e., customer identification and respective unique identification of water treatment system) between the customer and the water treatment system;
establishing a connection between the water treatment system and the main server for relaying information between the water treatment system and the personal computer.

16. The method of claim 15, wherein the step of providing a water treatment system having a unique identification includes a factory assigned unique identification.

17. The method of claim 15, wherein the step of establishing a connection includes automatically initiating the connection via the controller and a public wireless network or cellular modem.

18. The method of claim 15, wherein the step of receiving at the main server the association includes receiving the unique identification associated with the water treatment system and the corresponding customer identification via the personal computer.

19. The method of claim 15, wherein the step of establishing a connection includes establishing a connection between the personal computer and the main server, via the customer's router or other internet connection, wherein the personal computer and a router or other internet connection are located at the customer water treatment system installation site or a remote site.

20. The method of claim 15, further comprising, wherein the personal computer includes a web browser, the step of presenting via the main server to the personal computer a web based form, and receiving user provided information regarding the user, requested services, or data to be used for programming of the water treatment system, and storing the user provided information on the main server.

21. The method of claim 20, further comprising the step of receiving, by the main server, routine polling from the water treatment system for any updated user provided information or the step of the main server initiating connection with the water treatment system for providing updated user provided information.

22. The method of claim 15, further comprising the step the main server receiving user provided information identifying the location of the water treatment system, and the step of the main server providing a default settings for city water hardness and iron levels based on the zip code where the water treatment system is located, and further providing the step of the main server advising the user of any known contaminants in the water within the zip code area where the water treatment system is located, wherein the step of advising may be via email, a message delivered to the water treatment system, or via the main server when the user connects to the main server, and further comprising the step of recommending the purchase of a reverse osmosis filter to customers having a water treatment system located in an area where contaminants are located in the water source.

23. The method of claim 15, further comprising the step of detecting that the customer's salt level in the water treatment system is low, and the step of either notifying the customer that the salt level is low, or ordering a supply of salt be delivered, or dispatching a service personnel to the location to add salt to the water treatment system.

24. The method of claim 23, further comprising the step of selecting a supplier of services or product such as salt, wherein the steps of selecting includes certain criteria.

25. The method of claim 15, further comprising the step of receiving user provided information regarding the user, including an email address or SMS number of the user, and further comprising the step of dispatching an email or text message to the user advising of various sales or promotional, or the status of the water treatment system.

26. The method of claim 15, further comprising the step of receiving, by the main server, user requests for revised or additional service or product.

27. A method of controlling a water treatment system at a customer water treatment system installation site, wherein the customer or a representative of the customer has access to a personal computer having a web browser and capable of connecting to a network, the method comprising the steps of:
providing a main server at a location remote from a customer water treatment system installation site;
providing a water treatment system having a controller, and a unique identification, the water treatment system to be located at the customer water treatment system installation site;
establishing a connection between the water treatment system and the main server, the connection via a router or other internet connection located at the customer water treatment system installation site;
receiving at the main server the unique identification of the water treatment system, via the water treatment system;
establishing a connection between a personal computer and the main server;
receiving at the main server an association (i.e., customer identification and respective unique identification of the water treatment system) between the customer and the water treatment system;
establishing communication between the water treatment system and the main server, for relaying information between the water treatment system and the personal computer.

28. The method of claim 27, wherein the step of providing a water treatment system having a unique identification includes a factory assigned unique identification.

29. The method of claim 27, wherein the step of establishing a connection includes automatically initiating the connection via the controller.

30. The method of claim 27, wherein the step of receiving at the main server the association includes receiving the unique identification associated with the water treatment system and the corresponding customer identification via the personal computer.

31. The method of claim 27, wherein the step of establishing a connection includes establishing a connection between the personal computer and the main server, via the customer's router, wherein the personal computer and a router are located at the customer water treatment system installation site or a remote site.

32. The method of claim 27, further comprising the step of presenting via the main server to the personal computer a web based form, and receiving user provided information regarding the user, requested services, or data to be used for programming of the treatment system, and storing the user provided information on the main server.

33. The method of claim 32, further comprising the step of receiving, by the main server, routine polling from the water treatment system for any updated user provided information.

34. The method of claim 27, further comprising the step the main server receiving user provided information identifying the location of the water treatment system, and the step of the main server providing a default settings for city water hardness and iron levels based on the zip code where the water treatment system is located, and further providing the step of the main server advising the user of any known contaminants in the water within the zip code area where the water treatment system is located, wherein the step of advising may be via email, a message delivered to the water treatment system, or via the main server when the user connects to the main server, and further comprising the step of recommending the purchase of a reverse osmosis filter to customers having a water treatment system located in an area where contaminants are located in the water source.

35. The method of claim 27, further comprising the step of detecting that the customer's salt level in the water treatment system is low, and the step of either notifying the customer that the salt level is low, or ordering a supply of salt be delivered, or dispatching a service personnel to the location to add salt to the water treatment system.

36. The method of claim 35, further comprising the step of selecting a supplier of services or product such as salt, wherein the steps of selecting includes certain criteria.

37. The method of claim 27, further comprising the step of receiving user provided information regarding the user, including an email address or SMS number of the user, and further comprising the step of dispatching an email or text message to the user advising of various sales or promotional, or the status of the water treatment system.

38. The method of claim 27, further comprising the step of receiving, by the main server, user requests for revised or additional service or product.
